(19) United States
(12) Patent Application Publication
(10) Pub. No.: US 2011/0277679 A1
(43) Pub. Date: Nov. 17, 2011

(54) HAND HELD PARTICLE SENSOR DEVICE

(75) Inventors: Rick G. Good, Rockford, MI (US); Steve O. Mork, Lowell, MI (US); Thomas A. Niezgoda, Kentwood, MI (US); Sean T. Eurich, Holland, MI (US)

(73) Assignee: ACCESS BUSINESS GROUP INTERNATIONAL LLC, Ada, MI (US)

(21) Appl. No.: 13/107,130

(22) Filed: May 13, 2011

Related U.S. Application Data
(60) Provisional application No. 61/334,631, filed on May 14, 2010.

(51) Int. Cl. F21S 10/00; G01N 15/06

(52) U.S. Cl. 116/202; 73/61.71

(57) ABSTRACT

A hand held particle sensing device includes a housing having a component portion that encloses a particulate sensor, and a handle portion extending from the component portion for enabling the device to be carried by a user. An onboard power source may be housed within the handle portion. A display is positioned on the housing for outputting a signal, such as a visual or audible signal, corresponding to the level of particulates sensed by the sensor. The device may include an air flow path extending through the device, which may be air tight and separate from the rest of the device. A controller may be connected to the power source, the particulate sensor and the display for operating the particulate sensor and the output display.

### BACKGROUND OF THE INVENTION

This invention relates to particle sensing devices. More particularly, this invention relates to hand held particle sensor devices for detecting particles suspended in the air and providing an output display corresponding to the particle level within a particular room or area.

Particle sensor devices, also referred to as air sampling devices, are commonly used to determine the quality of air in a particular space, such as home or workplace. These devices can be very complex and expensive, as well as difficult to operate. In addition, these devices may produce a large amount of difficult-to-interpret data, which requires a user to have a level of training and education to understand.

Many air sampling devices are quite large and heavy and thus do not lend themselves toward being portable. These sensor devices contain a high level of electronic components, such as display screens, gauges, numerical readouts, and printer devices. Additionally, many of these devices require external electric power—they cannot be operated from onboard power, such as from a battery.

### SUMMARY OF THE INVENTION

The present invention provides a hand held particle sensing device that is easy to use but still contains a sophisticated particle sensing system to provide accurate results. In one embodiment, the hand held device carries onboard power, in the form of a battery or other storage device, such that no electrical connection is required to operate the device.

In one embodiment, the device includes a housing having a component portion that encloses a particulate sensor, and a handle portion extending from the component portion for enabling the device to be carried by a user. The onboard power source may be housed within the handle portion. A display is positioned on the housing for outputting a signal, such as a visual or audible signal, corresponding to the level of particulates sensed by the sensor. The device may include an air flow path extending through the device, which may be air tight and separate from the rest of the device. In one embodiment, the air flow path includes an inlet formed in the component portion of the housing, an inlet gasket extending between the inlet and the particulate sensor, the particulate sensor, an outlet formed in the component portion, and an outlet gasket extending between the particulate sensor and the outlet.

In another embodiment, the device includes a controller connected to the power source, the particulate sensor and the display. The controller may control the particulate sensor to begin sampling upon the user pressing a power button. The particulate sensor may be activated to take a predetermined number of readings of the particle level within the sensor for a predetermined time period. In one embodiment, the controller sends said output signal to said display based on an average reading level of said predetermined number of readings. In another embodiment, the controller records a plurality of peak readings, each peak reading corresponding to the highest reading measured during a selected portion of the predetermined time period, and the controller assigns each of the peak readings a display level based on a comparison of each peak reading with a baseline reading of the particulate sensor, and the controller sends an output signal to the device display, the output signal based on a comparison of the display levels with a preselected lookup table.

The present invention further includes a method for operating a particle sensor device, the method including the steps of: grasping within a user's hand a handle portion of the device; pressing a button on the device to activate a particle sensor housed within the device, wherein the particle sensor begins taking readings of the particle levels in the air within the particle sensor; moving the device to a desired room for obtaining particulate level measurements; drawing air within the room through the device and the particle sensor housed within the device while the particle sensor is activated; and outputting a display signal on a device display, the display signal corresponding to the particulate level measured by the particle sensor.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front perspective view of one embodiment of the present invention.

FIG. 2 is an exploded view of one embodiment of the present invention.

FIG. 3 is a front perspective view of the present invention according to a second embodiment.

FIG. 4 is a first portion of a flow chart detailing the operation of the system.

FIG. 5 is a second portion of a flow chart detailing the operation of the system.

FIG. 6 is a view of the internal components of a sensor according to one embodiment of the present invention.

### DETAILED DESCRIPTION OF THE CURRENT EMBODIMENTS

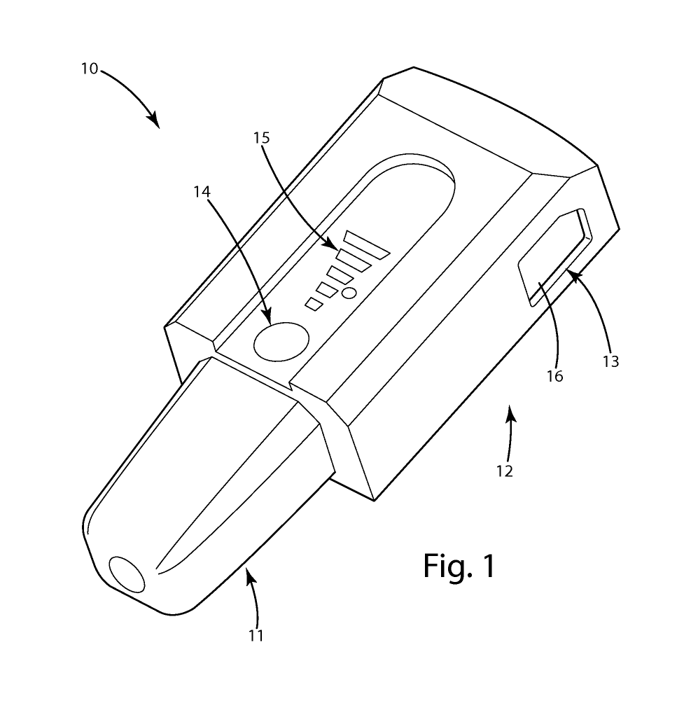

A hand held particle sensor device according to one embodiment of the present invention is shown in FIGS. 1-3 and generally designated 10. The hand held particle sensor device 10 allows a user to quickly and easily measure the level of particles in an airspace. In one embodiment, the device 10 includes a housing 100, a power switch 14 that is accessible to a user, a particle sensor 27 positioned within the housing 100, and a display 15 for providing the user an output that is indicative of the air quality.

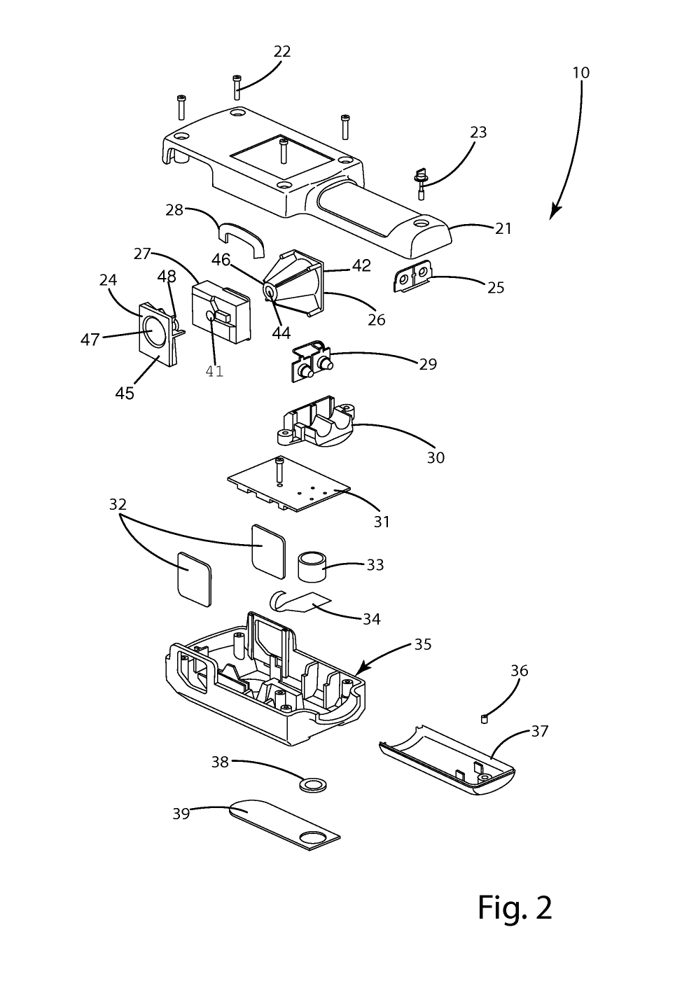

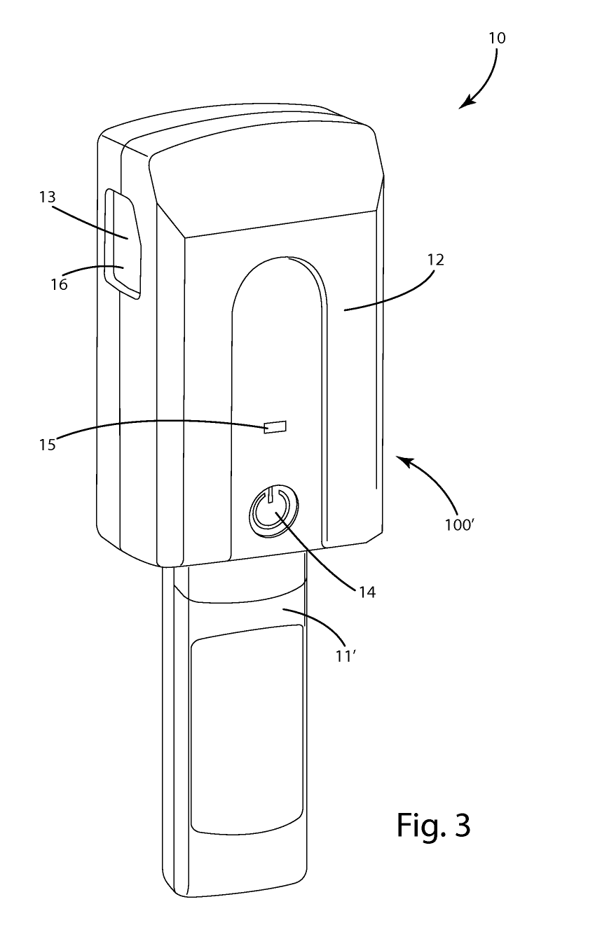

Referring to FIG. 1, a hand held particle sensor device 10 is shown according to at least one embodiment of the present invention. In the illustrated embodiment, the housing 100 may be formed from multiple pieces that are connected together to enclose the operational components of the device 10 and to form an aesthetic outer shell for the device 10. As shown, the housing may include an component portion 12 that contains the particle sensor 27 and other electronic components, and a grip portion 11 that forms a hand grip allowing a user to grasp the device 10. As shown in FIG. 2, an exploded view of the illustrated embodiment, the housing 100 may be formed in a clamshell fashion, with opposing pieces that attach together to form a hollow void therebetween. More particularly, in the illustrated embodiment, the housing 100 is formed from a first clamshell half 21 and a second clamshell half 35. The first and second clamshell halves may connect together with conventional fasteners, such as screws 22. The housing 100 may be formed from a variety of materials in a variety of methods. In one embodiment, the pieces of the housing 100 are formed from molded plastic. As shown, the first clamshell half 21 includes both a component portion 12 and a grip portion 11, whereas the second clamshell half 35 includes only a component portion 12. In one embodiment, the grip portion 11 of the second clamshell half 35 is formed from a separate piece 37, which forms a removable battery cover. The battery cover 37 may be removably connected to the first clamshell half with a cap screw 23 that is inserted through the first clamshell half 21 and further into a threaded insert 36 and the battery cover 37. An alternative embodiment of the housing 100′ is shown in FIG. 3. In this embodiment, the component portion 12 of the housing 100′ is substantially the same as the component portion 12 of the housing 100, whereas the grip portion 11′ has a different shape than the grip portion 11 of the housing 100. In particular, the grip portion 11′ has a generally uniform width and thickness along its length, whereas the grip portion 11 of the housing 100 tapers in width and thickness as it approaches the distal end.

As noted, the outer surface of the grip portion 11 forms a hand grip that enables a user to comfortably hold the device 10. One or more batteries (not shown) for powering the device 10 may be disposed within the hollow inner void of the grip portion 11. A first battery harness plate 25 is positioned at a lower end of the grip portion 11. A battery bracket 30 attached within the component portion 12 may extend into the grip portion 11 to support and position the batteries, and a second battery harness plate 29 is positioned on the battery bracket 30. When batteries are inserted into the grip portion 11, they are positioned such that opposing ends of each battery contact the first 25 and second 29 battery harness plates. The batteries may be replaceable units or rechargeable units. Alternatively the device may include a pass-through for charging the batteries while they remain onboard the device. In another embodiment, the device may include an inductive coil for receiving power wirelessly from a base station or charging surface. Additional or supplemental power sources may be used, such as capacitors, along with or individually to power the hand held device.

The component portion 12 of the housing 100 houses the main operational components of the device 10, including the particulate sensor 27 and circuit board 31. In one embodiment, a wire harness 28 is connected to the particulate sensor 27 and the circuit board 31. The wire harness 28 and circuit board 31 receive electrical power through the battery harness plate 29. The circuit board 31 may include a microprocessor (not shown) that is electrically connected to the particulate sensor 27 and the other electrical components of the device 10. As noted below, the microprocessor may be programmed with an algorithm to operate the particulate sensor 27 in a desired manner. In the illustrated embodiment, the device 10 includes a power button 14 provided on the outer surface of the device 10, which allows the user to activate the device as needed. The power button 14 is electrically connected to the circuit board 31 and the microprocessor so that the device 10 can be programmed to operate the particulate sensor 27 and any other desired electrical components upon actuation of the switch 14. A light source, such as LED's (not shown), may be mounted to the circuit board 31 or another portion of the device 10, and a reflector 33 may be positioned adjacent to the light source to concentrate light toward the display portion of the device. The light source may be electrically connected to the circuit board 31 (in particular, to the microprocessor) to enable the light source to be operated as a function of the particulate sensor 27. In one embodiment, the power button 14 includes a switch, which may be a touch switch 34. In the illustrated embodiment, the touch switch 34 is a capacitance switch, such as an indium titanium oxide (ITO) touch switch 34. The ITO touch switch includes a film, and a circuit on the film that is actuated by sensing the touch of the user. A lens 38 is attached to the upper housing over the touch switch 34, to allow for light from reflector 33 to escape to the outside of the device. The touch switch 34 is capable of sensing the touch of a user through the lens 38. Label 39 is affixed to the first clamshell half 21, adjacent to the power button 14 and the output display 15.

The output display 15 provides the user with an indication of the particle concentration as sampled by the device. In one embodiment, the output display includes a series of lights formed from the LED light source and reflector 33. The lights may be illuminated to show the user the particle level. For example, if the series of lights numbered five as in the illustrated embodiment, then a single light illumination may represent low particle concentration. A five light illumination may represent high particle concentration. A three light illumination may represent a mid-level value for particle concentration. In another embodiment, more or less lights may be used, depending upon the level of detail desired. The lights may be colored, such that the first lights may be green, the mid-level lights yellow, and the high level lights red. Alternatively or in conjunction with lights representing particle concentration levels, sound and/or numerical displays may be used. To provide the user with additional feedback, am audible tone may sound when air sampling begins and/or when air sampling ends. In addition, a digital display or gauge may be provided to enable the user to obtain numerical data. Additional or different display types may also be used. In one embodiment, the device also includes an LED that indicates that the system is active. For example, the LED may be visible through the power switch 14 and lens 38, and may turn on when a user touches the touch switch 34. The LED may remain on until the sensor 27 has completed taking measurements and the output display 15 indicating air quality level has been illuminated.

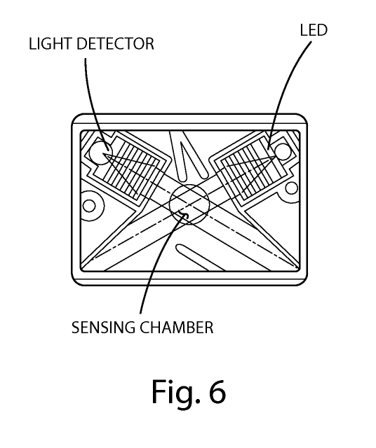

The particle sensor 27 positioned within the hand held device 10 may be capable of measuring the presence of particles in the air a number of ways. In one embodiment, shown in FIG. 6, the particle sensor may include a light source, such as a light emitting diode (LED), a photo-optic sensor (labeled “light detector” in the drawing) and a sensing chamber. The particle sensor may also include an internal controller and an electrical connector, such as a USB connector. In the FIG. 6 embodiment, when there are particles in the sensing chamber, some of the light from the LED is reflected onto the light detector. The more particles that are in the chamber, the more light gets reflected. The light detector outputs a voltage that is proportional to the amount of light reflected, and therefore proportional to the amount of dust particles in the sample. The sensor 27 shown in the illustrated embodiment is a compact particulate sensor, such as Model No. GP2Y1010AU made by SHARP. In one embodiment, the controller of the particulate sensor 27 is electrically connected to the microprocessor on the circuit board 31 via the sensor's electrical connector. The connection between the particle sensor 27, the circuit board 31 (via the microprocessor) and the display unit 15, allows the display unit 15 to inform the user of the particle concentration level.

At least one air passage 13 is defined within the device 10 to create a flow path for sample air to enter the device 10, pass through the particle sensor 27, and then exit the device 10. In the illustrated embodiment, the air passage 13 includes an inlet 16 on a first side of the housing 100 and an outlet (not shown) on the opposite side of the housing 100. The air passage 13 may include a first screen or mesh cover 32 positioned within the housing 100 at the inlet 16, a first sensor gasket 26 positioned between the first screen 32 and an inlet surface of the particle sensor 27, a second sensor gasket 24 adjacent to the outlet surface of the particle sensor 27, and a second screen 32 positioned within the housing at the outlet. In one embodiment, the air passage 13 may form an airtight flow path within the device 10 to isolate the air passing through the sensor 27 from the rest of the device 10. For instance, the sensor gaskets 24, 26 may each engage the housing 100 and the particle sensor 27 to create airtight seals at both ends of the gaskets 24, 26. As shown, the particle sensor 27 includes an outlet hole 41 defined in the outlet surface of the particle sensor 27. The particle sensor 27 may additionally include in inlet hole (not shown) on the opposing inlet surface of the particle sensor 27. The inlet hole may be the same size as the outlet hole 41. In one embodiment, the first and second sensor gaskets 26, 24 may be shaped to direct air flow through the air passage 13 and the sensor 27 in a desired manner. For example, the first gasket 24 may have a generally conical shape that tapers from a large opening at a first end 42 of the gasket 26 to a smaller opening 44 at a second end 46 of the gasket 26. The size of the opening 44 may be approximately the same as the size of the inlet of the sensor 27. In this way, the gasket 26 functions to funnel air into the inlet of the sensor 27. The second gasket 24 may include an inlet opening (not shown) at a first end 45 of the gasket 24 that is approximately the same size as the outlet 41 on the sensor 27, and an outlet 47 at a second end 48 of the gasket 24 that is larger than the gasket inlet. As shown, the length of the first gasket 26 between its first end 42 and its second end 46 is longer than the length of the second gasket 24 between its first 45 and second 48 ends. The screen meshes 32 are located between the sensor gaskets 24, 26 and the inlet 16 and outlet to prevent foreign objects from entering the particulate sensor, while still allowing for air flow through the air passage 13.

A small fan may be located adjacent to the sensor to move air through the device, into an area where particles are measured. For example, the fan may be positioned within the air passage 13 between one of the sensor gaskets 24, 26 and the sensor 27, or between one of the screens 32 and the adjacent gasket 24, 26. In one embodiment, one of the gaskets, such as gasket 26, may be modified to house the fan. The fan may include a motor that is electrically connected to the circuit board 31, and, more particularly, to the microprocessor, to enable the microprocessor to control the operation of the fan motor. When the fan motor is turned on, the fan operates to draw air into the air passage 13, through one of the gaskets 24, 26, through the sensor 27, and out of the other gasket 24, 26 to exhaust the air to the environment. Alternatively (as in the illustrated embodiment), the device 10 may not include a fan. In this embodiment, air may be drawn through the sensor by a user grasping the device and moving it through the air, such as in a sweeping arc motion, to create airflow through the device and through the sensor. Once sufficient air has moved through the device, the display may be lit to indicate the level of particle concentration in the airspace.

In operation, a user holds the hand held particle sensor device 10 in his/her hand, and presses the power button 14. The actuation of the power button 14 initiates a microprocessor algorithm for energizing the particle sensor 27, such that the particle sensor 27 becomes ready to take a reading of the air in the vicinity of the device.

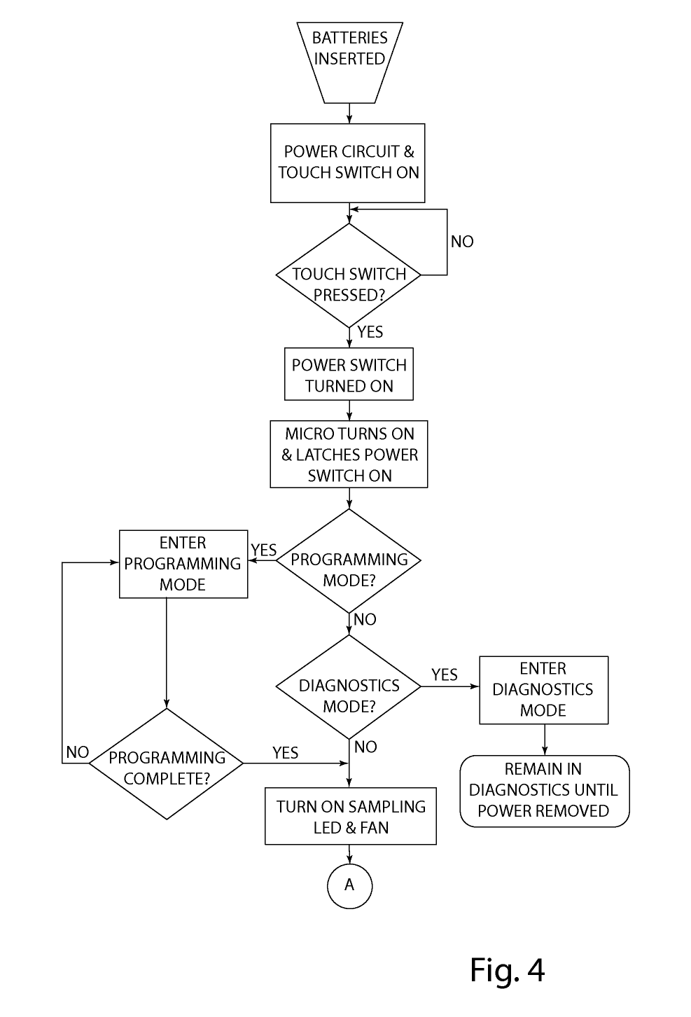

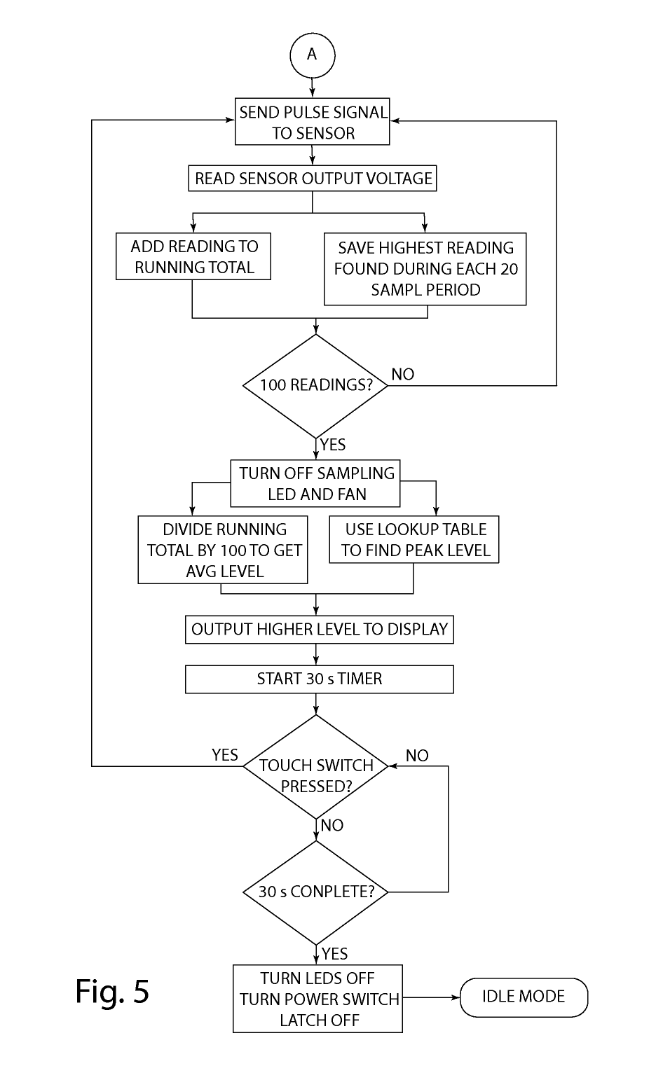

FIGS. 4 and 5 show a flow chart with one embodiment of the algorithm for operating the device 10. In this embodiment, the algorithm initiates with the installation of the batteries. The circuit and microprocessor become functional, and capable of receiving a signal from the power switch 14. The device 10 remains in an idle mode until the microprocessor receives a signal that the power switch has been turned on. When the power switch has been turned on, the microprocessor checks for a signal from an external device. The microprocessor may have one or more input sources, such as a USB or other physical connector, or an infrared or other wireless connection, to receive any input from an external device. The external device may be a separate controller for programming the device, such as a firmware upgrade, or for conducting diagnostics on the device.

If no external device is found within a predetermined time period, such as one or two seconds, the microprocessor turns on the particle sensor 27. In an embodiment including an internal fan, the microprocessor also turns on the fan to draw air through the sensor. In an embodiment with no internal fan, the user grasps the device 10 and waves the device 10 back and forth so that air may flow through the air passage 13, including through the housing inlet 16, the first gasket 24, the particle sensor 27, the second gasket 26 and the outlet. The microprocessor sends a pulse signal to the particle sensor, such that the particle sensor 27 begins to sample the number of particles in the air passing through the sensor 27, and the microprocessor reads the output voltage of the sensor 27. In the embodiment illustrated in FIG. 5, the particle sensor 27 samples the air until it has taken 100 readings. The 100 readings may be taken during a generally predetermined time period, such as about five (5) seconds, whereby the sensor 27 takes about 20 readings per second. The microprocessor may compile the readings outputted by the sensor 27 in a variety of ways. In the illustrated embodiment, the readings are compiled in two different ways. According to one method, all of the readings are summed to create a total particulate reading. The total is then divided by the number of readings (in this case, 100 readings) to obtain an average reading level.

According to a second method of compiling the sensor readings, which may be conducted at the same time as the first method, the highest reading for each 20 sample period is saved, such that a total of five (5) peak readings are saved for each 100 reading sample. The five peak readings are then used in connection with the following lookup table to determine a single reading to display:

| | | Column | | | | |
|---|---|---|---|---|---|---|
| | | 1 | 2 | 3 | 4 | 5 |
| | | # of Peaks measured: | | | | |
| Row | | 1 | 2 | 3 | 4 | 5 |
| 1 | Level 1 | 1 | 1 | 1 | 1 | 1 |
| 2 | Level 2 | 2 | 2 | 2 | 2 | 2 |
| 3 | Level 3 | 2 | 2 | 2 | 2 | 2 |
| 4 | Level 4 | 3 | 3 | 4 | 4 | 4 |
| 5 | Level 5 | 3 | 4 | 4 | 5 | 5 |

Each of the five (5) saved readings is assigned to a display level, Level 1 to Level 5. The display level is determined by comparing the saved peak reading to the sensor output when there are no particles to measure. The table is used to determine which of the display levels to output by finding the row and column associated with the number of peaks assigned to each display level, and then selecting the highest of those values. For example, if three of the peaks were assigned to Level 2 (column 3, row 2) and two of the peaks were assigned to Level 4 (column 2, row 4), the table indicates display values of 2 and 3 respectively. Because the higher of these values is 3, the output value would be 3. If three of the peaks were assigned to Level 1 (column 3, row 1) and two peaks were assigned to Level 5 (column 2, row 5), the output value would be 4. In one embodiment, the calculation of the average reading and the determination of the peak reading using the lookup table are conducted after the microprocessor has turned off the sensor sampling and the fan (if included).

In the illustrated embodiment, the calculated average reading is compared to the output value for the peak reading, and the greater of the two numbers is outputted to the device display 15. The information is displayed on the device's control area 15, which, as described above, may include a number of colored bars to represent low, medium, or high levels of particulates in the air. In the illustrated embodiment, the device includes five (5) LED's; however, alternative numbers of LED's may be used, or, in another embodiment, the device display may include an audible tone, or another visual signal.

Finally, after the particulate level has been outputted to the display 15, the device may be programmed to repeat the operation of the particle sensor to take a new reading, or to enter an idle mode with the sensor 27, LED's, and motor (if included) turned off. In the illustrated embodiment, the device enters the idle mode if the power switch is not pressed within a 30 second interval following the display of the particulate level.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A hand held particle sensor comprising:
a housing having a component portion and a handle portion extending from said component portion;
a particulate sensor enclosed within said component portion, said particulate sensor capable of sensing a characteristic of air within said particulate sensor;
a power source enclosed within said handle portion, said power source in electrical communication with said particulate sensor; and
a display on said housing, said display connected to said particulate sensor and capable of outputting a signal corresponding to said characteristic of air sensed by said particulate sensor.

2. The hand held particle sensor of claim 1 wherein said component portion includes an air tight flow path extending through said component portion, said flow path including an inlet, an outlet and said particulate sensor, wherein air is capable of flowing into said inlet, through said particulate sensor, and out of said outlet.

3. The hand held particle sensor of claim 2 wherein said air flow path includes an inlet gasket positioned between said inlet and said particle sensor, and an outlet gasket positioned between said particle sensor and said outlet.

4. The hand held particle sensor of claim 3 wherein said inlet gasket and said outlet gasket has a generally conical shape that tapers from a large opening at a first end of the gasket to a smaller opening at a second end of the gasket, wherein said at least one gasket functions to funnel air into said sensor.

5. The hand held particle sensor of claim 4 wherein said component portion includes top, bottom, left side and right side surfaces, wherein said inlet is positioned on said left side surface and said outlet is positioned on right side surface, wherein a width of said component portion is defined between said left and right side surfaces, wherein said handle portion extends from said bottom of said component portion, said handle portion including a handle width extending in the same direction as said component portion width, said handle width being smaller than said component portion width to enable grasping of said handle portion by a user.

6. A hand held particle sensor comprising:
a housing having a component portion and a handle portion, said handle portion defining an internal battery compartment, said handle portion including an electrical contact within said compartment;
a particulate sensor within said component portion, said particulate sensor in electrical communication with said contact, said particulate sensor capable of sensing a characteristic of air flowing through said particulate sensor; and
an air flow path defined within said component portion of said housing, said air flow path including an inlet defined in said component portion, an outlet defined in said component portion, and said particulate sensor;
a display on said housing, said display connected to said particulate sensor such that said display outputs a signal corresponding to said characteristic of air sensed by said particulate sensor.

7. The hand held particle sensor of claim 6 including a controller connected to said electrical contact, said particulate sensor and said display, said controller receiving an input signal from said particulate sensor, said controller providing an output signal to said display based on said input signal from said particulate sensor.

8. The hand held particle sensor of claim 7 including a power button on said housing, said power button connected to said controller, wherein upon actuation of said power button, said controller signals said particulate sensor to begin sampling the air passing through said particulate sensor.

9. The hand held particle sensor of claim 8 wherein said particulate sensor samples the air passing through said particle sensor for a predetermined time period, said sensor taking a predetermined number of readings during said predetermined time period.

10. The hand held particle sensor of claim 9 including a light indicator visible on the exterior of said housing for indicating that said particle sensor is active, said light indicator activated upon a user pressing said power button, said light indicator remaining on until the end of said predetermined time period.

11. The hand held particle sensor of claim 9 wherein controller sends said output signal to said display based on an average reading level of said predetermined number of readings.

12. The hand held particle sensor of claim 10 wherein said controller is programmed to record a plurality of peak readings, each peak reading corresponding to the highest reading measured during a selected portion of said predetermined time period.

13. The hand held particle sensor of claim 12 wherein said controller assigns each said peak reading a display level based on a comparison of each said peak reading with a baseline reading of said particulate sensor.

14. The hand held particle sensor of claim 13 wherein said controller sends said output signal to said display based on a comparison of said display levels with a preselected lookup table.

15. A method for operating a particle sensing device comprising:
grasping within a user's hand a handle portion of the device;
pressing a button on the device to activate a particle sensor housed within the device, wherein the particle sensor begins taking readings of the particle levels in the air within the particle sensor;
moving the device to a desired room for obtaining particulate level measurements;
drawing air within the room through the device and the particle sensor housed within the device while the particle sensor is activated; and
outputting a display signal on a device display, the display signal corresponding to the particulate level measured by the particle sensor.

16. The method of claim 15 wherein the step of drawing air through the device includes moving the device within the room while grasping the device such that air enters the device through a device inlet.

17. The method of claim 15 wherein the step of drawing air through the device includes actuating a fan housed within the device.

18. The method of claim 16 wherein the device includes a controller, the controller activating the particle sensor to take a predetermined number of the readings for a predetermined time period.

19. The method of claim 18 wherein controller sends an output signal to said device display based on an average reading level of said predetermined number of readings.

20. The method of claim 18 wherein the controller records a plurality of peak readings, each peak reading corresponding to the highest reading measured during a selected portion of the predetermined time period, and the controller assigns each of the peak readings a display level based on a comparison of each peak reading with a baseline reading of the particulate sensor, and the controller sends an output signal to the device display, the output signal based on a comparison of the display levels with a preselected lookup table.
